(19) United States
(12) Patent Application Publication
(10) Pub. No.: US 2013/0291535 A1
(43) Pub. Date: Nov. 7, 2013

(54) ACTUATING DEVICE, METHOD FOR OPERATING AN ACTUATING DEVICE, AND SOLENOID VALVE ARRANGEMENT

(71) Applicants: Heinz Leiber, Oberriexingen (DE); Carsten Hecker, Munich (DE)

(72) Inventors: Heinz Leiber, Oberriexingen (DE); Carsten Hecker, Munich (DE)

(73) Assignee: IPGATE AG, Pfaffikon (CH)

(21) Appl. No.: 13/980,438

(22) PCT Filed: Jan. 9, 2012
(86) PCT No.: PCT/EP12/00061

§ 371 Date: Jul. 18, 2013

(30) Foreign Application Priority Data
Jan. 20, 2011 (DE) 10 2011 009 059.2

(51) Int. Cl. F15B 15/00

(52) U.S. Cl. CPC F15B 15/00
USPC 60/545; 251/129.15; 60/327

(57) ABSTRACT

The invention relates to an actuating device, in particular for a vehicle brake, wherein hydraulic fluid is supplied to an actuator, in particular a wheel brake, from a piston-cylinder unit via a first hydraulic connection and a solenoid valve. According to the invention, it is provided that a further hydraulic connection connects the piston-cylinder unit to a hydraulic liquid container, and in that a solenoid valve device is arranged in this connection, which solenoid valve has at least two valves which are effective in different flow directions.

The invention relates to an actuating device, in particular for a vehicle brake, wherein hydraulic fluid is supplied to an actuator, in particular a wheel brake, from a piston-cylinder unit via a first hydraulic connection and a solenoid valve.

### PRIOR ART

The following requirements are placed on new generations of brake systems:

(a) Use of a pedal path simulator, with the help of which the driver's desire to brake is recorded in intact brake systems and fed into an electronic control device for further processing.

(b) A very good fallback level in the case of a failure of the brake booster (BB). This requires a small main cylinder diameter, but this causes large strokes and a long structure. In order to avoid this, return feed devices with overpressure and storage are known from DE 10 2007 062839. Furthermore, to this end it has already been suggested to achieve the compressed air supply by means of additional pistons which are actuated by the main cylinder piston driver or a backing pump which feeds volumes into the brake circuit as necessary (DE 10 2010 055044). All solutions with overpressure have the advantage that the return feed is rapidly achieved.

(c) High degree of error proofing. There are many conceivable instances of this. Among other things, it is conceivable that an electromotive drive of the main cylinder sticks via a gearbox during heavy braking, and subsequently no reduction in pressure is possible. A valve is suggested in DE 10 201 0050508 and DE 10 2010 045617 for this purpose, which releases the pressurised medium into the storage container.

(d) No or low pedal backlash on ABS and recuperation. For this purpose, it has been suggested to release pressurised medium from at least one brake circuit by means of a switch valve in the storage container. In this way, for example a piston position which at low pressure is almost in the initial position, cannot collide with the pedal tappet but rather achieves a higher stroke position by means of the volumes taken from the main cylinder. This is known as free travel clearance. Advantageous for this feature is a coaxial arrangement in which the tandem main cylinder has a dual role: generating pressure and rapid return feed of volumes with corresponding switch devices.

### OBJECT OF THE INVENTION

The object of the present invention is to create an actuating device of the type mentioned at the outset, in particular for vehicle brakes, which combines the advantages of the existing solutions described in the prior art with the lowest possible cost.

### ACHIEVEMENT OF THE OBJECT

The object is achieved according to the invention in that an additional hydraulic connection connects the piston-cylinder unit to a hydraulic fluid container, and in that a solenoid valve device is arranged in this connection, which solenoid valve has at least two valves which are effective in different flow directions.

In other words, according to the invention a bidirectional valve device is provided, with the help of which in a vehicle brake pressurised medium from the brake circuit, in particular at high levels of pressure, can be released into the storage container and in the second direction when there is rapid suctioning of the storage container volumes reach a working area in the piston-cylinder unit.

Advantageous embodiments of the invention can be derived from the dependent claims.

The valves have expediently, in particular very (greater by a factor of 5) different valve opening cross sections.

Both flow paths can be electrically switched. With a switch valve with a small opening cross section, this means a high pressure level can be achieved e.g. 150 bar, and for a switch valve with a large cross section a low pressure level can be achieved. Preferably both valve functions are carried out with a bidirectional two-stage valve with an additional valve body and only one actuating magnet. According to the prior art, valves of this type with additional valve bodies are known as two-stage valves, for example from U.S. Pat. No. 2,914,086, EP 0783422, DE 19855667. These valves only operate in one direction, in which volumes are suctioned from the main cylinder by the return pump. This increases the pressure in the brake circuit for injection pumps and brake assist functions. In the present invention, the valve arrangement is bidirectional in two directions.

In the first function and direction a first valve (valve stage) is connected to build up pressure from the brake circuit in the storage container and in the second function the second valve (valve stage) is connected in the opposite direction from the storage container to the suctioning main cylinder. The suctioning main cylinder is necessary for smaller dimensioning for the fallback level described for return feeding of volumes into the brake circuit e.g. during fading. The function of the return feed is also necessary when the main cylinder must offset the volume consumption in ABS, e.g. by building up the pressure in the storage container, as described in detail by the applicant in the applications DE 10 2010 050508 and DE 10 201 0 055044, which are taken into account here. In both cases, the return feed time should be small in order that where appropriate the interruption of the pressure build-up is only short. Either an overpressure or a valve with a large cross section >10 mm² is necessary for this. Expediently therefore in embodiments of the valve device according to the invention the following measures may be provided individually or in combination:
Filter on the input and output for the bidirectional operation of the valve function without dirt particles
Design of the annular valve seat, preferably with elastomeric sealing elements in the valve body with a limitation of the deformation by means of an end stop and sufficient sealing force via a spring
Positioning of the sealing element on the valve seat with good centring
Relevant stroke in the magnet armature and design of the armature pole in order to keep the excitation of the magnetic circuit (current and number of windings) low

The solution according to the invention and its embodiments enable the substantial advantages of the known solutions to be maintained and a safe and cost-effective function to be ensured in a surprisingly simple and effective manner.

Exemplary embodiments of the invention and their arrangements are shown in the figures and described in greater detail below, whereby:

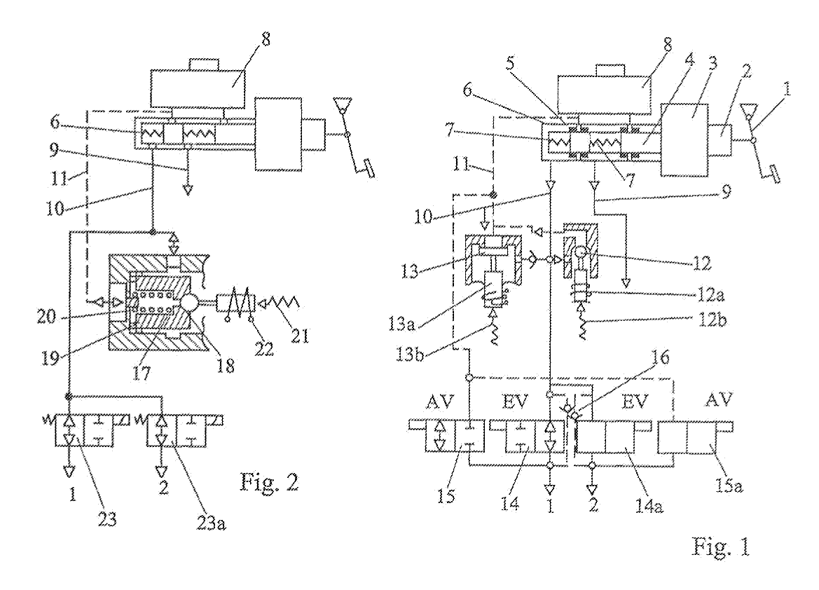

FIG. 1 shows an actuating device for a brake system with a valve function;

FIG. 2 shows an actuating device for a brake system with a two-stage valve; and

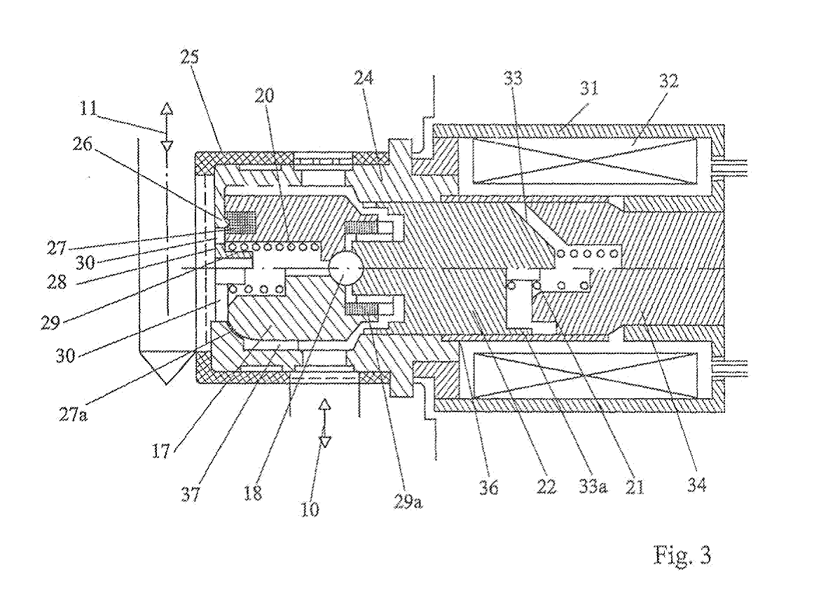

FIG. 3 shows the constructive design of the two-stage valve.

The brake system shown in FIG. 1 has a brake pedal 1, a travel simulator 2, an, in particular electromotively driven, brake booster (BB) 3, push rod pistons 4 and storage chamber pistons 5 in the tandem main cylinder housing 6 having piston return springs 7 and therefore has the typical structure as described in detail by the applicant in DE 10 2010 045617 which is taken into account in full here. In this brake system, an electromotively driven brake booster and a gearbox are provided, which gearbox is couples to the main cylinder piston (push rod piston), in particular by means of a permanent magnetic coupling, such that this or the wheel brakes can be operated in multiplex processes in which the pressure in the individual wheel brakes can be set by means of one valve per wheel brake simultaneously or successively. An auxiliary cylinder with auxiliary pistons and return springs is coaxially connected to the booster, wherein the auxiliary cylinder is connected to a hydraulic travel simulator by means of a throttle return valve and to the storage container of the brake system by means of a solenoid valve. Redundant pedal path sensors are coupled to the auxiliary pistons, which sensors control the motor of the BB and actuate the solenoid valve. The desired backlash on the pedal force is generated by the route simulator. If there is a failure of the travel simulator, for example sticking, pressurised medium can flow to the storage container via the solenoid valve. Furthermore, in the system according to DE 10 2010 045617 a line can be provided from the auxiliary cylinder to the main cylinder in which a solenoid valve is connected such that in the lower pressure region of the auxiliary pistons pressurised medium can be fed into the relevant brake circuit and, where appropriate, back by means of this solenoid valve.

In the embodiment of the brake system shown in FIG. 1, two control valves for ABS 14, 14a, 15, 15a are provided in the brake circuits or the lines leading to the individual wheel brakes. In other words, the invention can be used in both systems of this type and in the system described above in connection with DE 10 201 0 045617.

A first line 10 connects the valve inlet of the valve 12 to the main cylinder or the brake circuit associated with the floating pistons.

The valve outlet is connected to a second line 11 which leads to the storage container 8 and to the inlet of the valve 13. The outlet of the valve 13 is connected to the inlet of the valve 12. The line 11 is connected to the outlet valves 14, 14a, by means of which the brake fluid is fed to the storage container.

The valve arrangement consists of a valve 12 with a small cross section and a valve 13 with a large cross section. The valve 12 is used to release pressure in the storage container (8) for the functions of hydraulic free travel clearance and sticking drive. The free travel clearance means that in particular in the case of low friction values in the pressure modulation for ABS, the pedal tappet can connect with the main cylinder pistons (push rod piston), resulting in undesirable backlashes. In order to avoid this completely or partially, pressurised medium is transferred from the brake circuit(s) into a storage or a container, extending the piston travel accordingly. When the gap between the piston tappet and the pedal tappet becomes too large, conversely brake fluid can be guided back from the storage or container into the brake circuit, as described in detail by the applicant in DE 10 2009 055721 which is taken into account here. The currentless closed valve 12 is closed by the valve closing spring 12b and opened by the magnet armature when there is flow. When the valve 12 is open, pressurised medium can flow from the main cylinder to the storage container via the line 10, the valve 12 and the line 11.

The structure of the valve 13 is identical to the valve closing spring 13b and the magnet armature 13a, with the difference that it has a considerably larger cross section for rapid suctioning when there is flow in the armature 13a. In this way, pressurised medium is suctioned from the storage container (8) via the line 11 by means of appropriate piston control of the push rod and floating piston. After suctioning is complete, the valve 13 is switched off again and the piston is moved to a larger stroke again to further increase pressure. For this process, the EV valves 14 and 14a must be designed without the usual return valve 16 as pressurised medium flows from the wheel circuits into the main cylinder during suctioning with a return valve. The construction of the EV valves is achieved using a reinforced magnet circuit and valve springs.

FIG. 2 contains the same functions by simplification of the valves to form a two-stage valve. The valve is connected to the brake circuit 10 via the main cylinder and to the storage container 8 by means of the line 11.

Similarly, in FIG. 1 in the one direction the small valve 18 is opened by means of flow from the magnet armature 28 to release pressure. In this process, the flow strength at high pressure is so great that the second valve remains closed. Valve 18 is also opened for suctioning in the other flow direction. In this process, the return spring acts with the pressure components to open the valve seat on the valve body 17. In contrast to suctioning by means of return valves with corresponding loss of pressure, this does not occur with the valve arrangement.

Only one switch valve 23, 23a per wheel circuit is necessary for pressure modulation ABS in this exemplary embodiment. This corresponds to the multiplex processes described above, as described in detail by the applicant in DE 10 2005 055751, which is taken into consideration here.

FIG. 3 shows the constructive structure of a solenoid valve according to the invention having a magnet circuit consisting of a magnet cover 31, chokes 32, pole piece 34 and a non-magnetic welded length of pipe 36.

A sealed closure is necessary for the valve function, a filter in both directions serves primarily for this.

If there is a large valve seat, preferably an elastomeric seal 27 is used in the valve body 17, which is placed on an annular sealing seat 26.

In this way, the deformation is limited by an end stop 28. The valve body lies on this and through appropriate dimensioning the clearances of the valve housing 24 having sealing seat 26 and valve body 17 having sealing 27. The pressing force without pressure is achieved by means of valve closing springs 21, the closing force of which is increased under pressure. Alternatively to the flat seal, a valve body with a ball may also be used. This is more sensitive to dirt, but does not require an end stop. The sealing body has an opening spring which acts against the valve closing spring. The resulting force must be measured to be so large that both valve seats are sealed even at low pressure. On the opposite side, the small valve seat 18 is preferably formed as a ball seat. The ball is rigidly connected to the armature 22.

For the valve function, it is important that the valve body is centred and mounted on the valve seat. On the side with the large valve seat, the valve body is mounted in the case of flat sealing on a journal 29 of the valve housing 24 or in the case of a ball seat also in the valve housing 24 by means of a web 37 which is not interrupted on the circumference.

In small valve seats, the valve body is mounted above a bearing bush 29a on the armature. When there are high through flow volumes, an annular gap must be provided between the valve body 27 and the valve housing 24. The axial annular gap is determined by the armature stroke. Corresponding to the large valve cross section, this is considerably larger than in normal solenoid valves. In order to keep the excitation (current strength×number of turns) low despite this, the armature pole is conical 33 or designed with a known pole shape 33a (see lower half). The magnet armature and the magnet pole are designed for a larger stroke than in normal solenoid valves for the ESP function (around 0.25-0.35 mm) for use. In particular, in the invention a region from approximately 0.5 or approximately a factor of 2 of the average values for ESP is to be provided for this.

With the solution according to the invention, the function of a bidirectional valve with strongly varying cross sections and pressures can be designed in a small, reliable and cost-effective manner.

### REFERENCE NUMBER LIST

1 Brake pedal
2 Travel simulator
3 Brake booster
4 Push rod piston
5 Storage chamber piston
6 Tandem main cylinder housing
7 Piston return spring
8 Storage container
9 Push rod piston brake circuit
10 Storage chamber brake circuit
11 Line to the storage container
12 Valve 1
12a Magnet armature 1
12b Valve closing spring 1
13 Valve 2
13a Magnet armature 2
13b Valve closing spring 2
14 EV1
14a AV1
EV 2
15a AV2
16 Return valve
17 Valve body
18 Small valve seat
19 Large valve seat
20 Opening spring valve body
21 Valve closing spring
22 Magnet armature
23 Switch valve 1
23a Switch valve 2
24 Valve housing
25 Filter
26 Large valve seat
27 Elastomeric sealing body
27a Ball sealing body
28 End stop
29 Storage 1
29a Bearing bush 2
30 Passage
31 Magnet cover
32 Chokes
33 Ball armature
34 Pole piece
35 Pole shaping
36 Length of pipe
37 Guide web

1. An actuating device for a vehicle brake, the actuating device including:
a piston-cylinder unit;
a first hydraulic connection and a solenoid valve coupled between the piston-cylinder unit to a wheel brake and configured to supply hydraulic fluid from the piston-cylinder unit to the wheel brake;
a hydraulic fluid container; and
an additional hydraulic connection, including a solenoid valve device, the additional hydraulic connection being configured to connect the piston-cylinder unit to the hydraulic fluid container,
wherein the solenoid valve device has at least two valves or valve seats, which are effective in different flow directions.

2. The actuating device according to claim 1, wherein the piston-cylinder unit is the main cylinder of the vehicle brake.

3. The actuating according to claim 1, wherein the hydraulic fluid container is the storage container of the vehicle brake.

4. The actuating according to claim 1, wherein the valves have different valve opening cross sections.

5. A method for operating an actuating device for a vehicle brake, wherein hydraulic fluid is supplied to a wheel brake from a piston-cylinder unit via a first hydraulic connection and a solenoid valve, the method including:
releasing, by means of a bidirectional valve device, pressurized medium from a brake circuit into a container at high pressure, and
suctioning volumes from the container into the piston-cylinder unit by means of the bidirectional valve device.

6. A solenoid valve arrangement for an actuating device, including:
a first valve device with a first valve seat and a first mobile valve body, and
a second valve device with a second valve seat and a second mobile valve body,
wherein the first and second valve devices form different valve cross sections, and
wherein the valve devices are effective in different flow directions.

7. (canceled)

8. The solenoid valve arrangement according to claim 6, wherein the first and second valve devices are arranged in a common housing, and wherein one of the first or second valve seats is formed by the housing.

9. The solenoid valve arrangement according to claim 8 8, wherein at least one of the mobile valve bodies in the housing is arranged in an axially displaceable manner and is supported on the housing by guide elements or guide webs.

10. The solenoid valve arrangement according to claim 6, wherein at least one of the mobile valve bodies has a seal on its front face which interacts with the respective valve seat corresponding to the respective mobile valve body.

11. The solenoid valve arrangement according to claim 6, further comprising a guide provided between the valve bodies of the valves.

12. The solenoid valve arrangement according to claim 6, wherein at least one of the first or second valve body has a radial guide on each face, which radial guide corresponds to the relevant valve seat.

13. The solenoid valve arrangement according to claim 6, further comprising a magnet armature and a magnet pole.

14. The solenoid valve arrangement according to claim 6, further comprising a guide bush or a bearing bush provided between the valve bodies of the valves.
